(19) United States
(12) Patent Application Publication
(10) Pub. No.: US 2016/0045915 A1
(43) Pub. Date: Feb. 18, 2016

(54) TUBE AND FLOAT SYSTEMS AND METHODS OF USING THE SAME

(71) Applicant: RareCyte, Inc., Seattle, WA (US)

(72) Inventors: Jonathan Lundt, Ann Arbor, MI (US); Joshua Nordberg, Bainbridge Island, WA (US)

(73) Assignee: RareCyte, Inc., Seattle, WA (US)

(21) Appl. No.: 14/823,867

(22) Filed: Aug. 11, 2015

Related U.S. Application Data
(60) Provisional application No. 62/036,442, filed on Aug. 12, 2014.

(51) Int. Cl. B01L 3/00

(52) U.S. Cl. CPC B01L 3/50215; B01L 2200/0652; B01L 2300/168; B01L 2300/16; B01L 2300/12

(57) ABSTRACT

Systems for analyzing target materials of a suspension include a tube and a float in which at least a portion of the float is porous. The at least one pore can allow for the flow of fluids and reagents out of the float and into a space between the outer surface of the float and the inner surface of the tube. The at least one pore can also prevent unwanted particles or material from flowing into the float. The introduction of additional fluids, such as fixing agents, washing agents, detergents, or labeling agents, may aid in further processing or detection of the target analyte. The porosity of the float may also allow for the target analyte to be extracted through the float by introducing a removal device, such as a vacuum, to draw the target analyte through the float and into the vacuum.

### CROSS-REFERENCE TO A RELATED APPLICATION

This application claims the benefit of Provisional Application No. 62/036,442, filed Aug. 12, 2014.

### TECHNICAL FIELD

This disclosure relates generally to density-based fluid separation and, in particular, to tube and porous float systems for the separation and axial expansion of constituent suspension components layered by centrifugation.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as fetal cells, endothelial cells, epithelial cells, parasites, bacteria, and inflammatory cells, and viruses, including HIV, cytomegalovirus, hepatitis C virus, and Epstein-Barr virus and nucleic acids. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 3 CTCs is considered clinically relevant in the diagnosis and treatment of a cancer patient. However, detecting even 1 CTC in a 7.5 ml blood sample may be clinically relevant and is equivalent to detecting 1 CTC in a background of about 50 billion red and white blood cells. Using existing techniques to find, isolate and extract as few as 3 CTCs of a whole blood sample is extremely time consuming, costly and is extremely difficult to accomplish.

As a result, practitioners, researchers, and those working with suspensions continue to seek systems and methods to more efficiently and accurately detect, isolate and extract target materials of a suspension.

### SUMMARY

Systems for analyzing target materials of a suspension include a tube and a float in which at least a portion of the float is porous. The at least one pore can allow for the flow of fluids and reagents out of the float and into a space between the outer surface of the float and the inner surface of the tube. The at least one pore can also prevent unwanted particles or material from flowing into the float. The introduction of additional fluids, such as fixing agents, washing agents, detergents, or labeling agents, may aid in further processing or detection of the target analyte. The porosity of the float may also allow for the target analyte to be extracted through the float by introducing a removal device, such as a vacuum, to draw the target analyte through the float and into the vacuum.

### DESCRIPTION OF THE DRAWINGS

FIGS. 1A-1B show isometric views of two example tube and porous float systems.

FIGS. 2A-2B show a porous float.

FIGS. 3-5 show examples of different types of porous floats.

FIGS. 6A-6C show a porous float.

FIGS. 7A-7B show a porous float.

FIGS. 8A-8B show a porous float.

FIGS. 9A-9C show a porous float.

FIGS. 10A-10B show a porous float.

FIG. 11 shows a fluid being introduced to a tube and porous float system.

FIG. 12 shows a target analyte being withdrawn from a tube and porous float system.

FIG. 13A shows an example tube and porous float system.

FIG. 13B shows a cross-sectional view of the tube and porous float system.

### DETAILED DESCRIPTION

The detailed description is organized into two subsections: A general description of tube and porous float systems is provided in a first subsection. Using tube and porous float systems to analyze target materials of a suspension is provided in a second subsection.

It should be understood that “fluid” includes a gas and a liquid, such as a solution (solute in a solvent) or a suspension (heterogeneous fluid with solid particles suspended within the heterogeneous fluid).

### General Description of Tube and Porous Float Systems

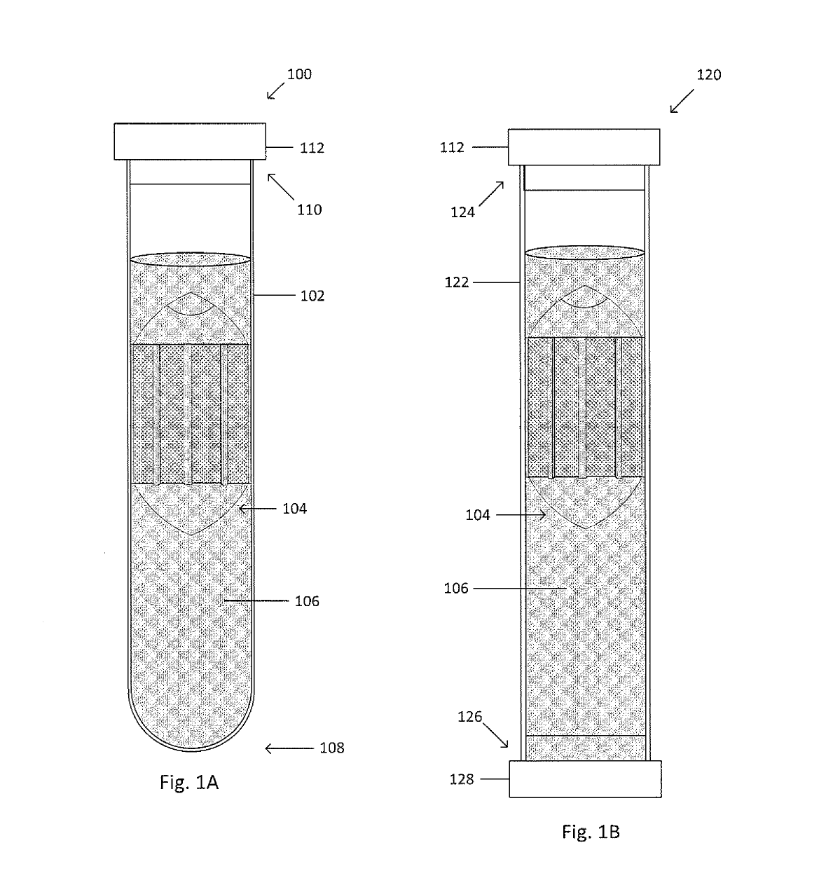

FIG. 1A shows an isometric view of an example tube and porous float system 100. The system 100 includes a tube 102 and a porous float 104 suspended within a suspension 106. In the example of FIG. 1A, the tube 102 has a circular cross-section, a first closed end 108, and a second open end 110. The open end 110 is sized to receive a stopper or cap 112. The tube may also have two open ends that are sized to receive stoppers or caps, such as the example tube and porous float system 120 shown FIG. 1B. The system 120 is similar to the system 100 except the tube 102 is replaced by a tube 122 that includes two open ends 124 and 126 configured to receive the cap 112 and a cap 128, respectively. The tubes 102 and 122 have a generally cylindrical geometry, but may also have a tapered geometry that widens, narrows, or a combination thereof toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as flexible plastic or another suitable material. The tube may also include a plug (not shown) at the closed end 108 to permit the removal of a fluid, the suspension, or a suspension fraction, whether with a syringe, by draining, or the like.

The tube may have a sidewall and a first diameter. The porous float can be captured within the tube by an interference fit. To remove the porous float from the tube after the porous float has been captured, the sidewall, being elastically radially expandable to a second diameter, may be expanded in response to an axial load, pressure due to centrifugation, external vacuum, or internally-introduced pressure, the second diameter being sufficiently large to permit axial movement of the porous float in the tube during centrifugation.

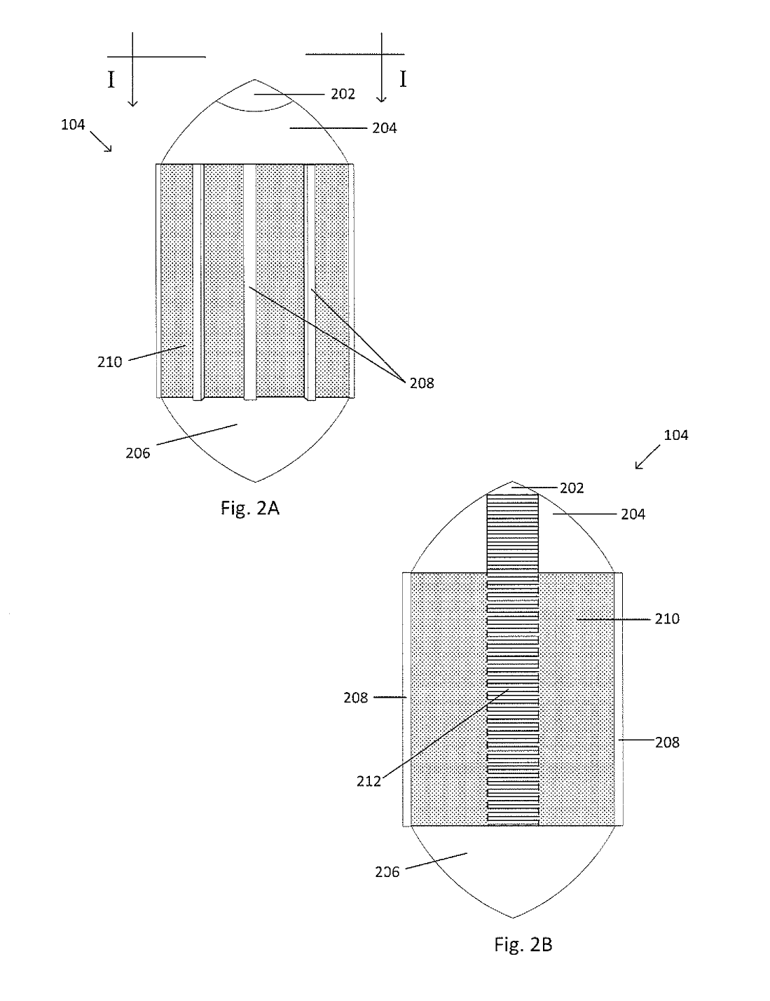

FIG. 2A shows an isometric view of the porous float 104 shown in FIG. 1. The porous float 104 includes a porous main body 210, two teardrop-shaped end caps 204, 206, and support members 208 radially spaced and axially oriented on the main body 210. The porous float can also include two dome-shaped end caps or two cone-shaped end caps. The support members 208 provide a sealing engagement with the inner wall of the tube 102. The porous float 104 may also include a pierceable segment 202. The pierceable segment 202 may be located in the top end cap 204 or the bottom end cap 206 through which fluids can be introduced. The porous float 104 may also include a porous layer (not shown) which may surround at least a portion of the porous main body 210 and/or the support members 208. The porosity of the main body 210 may be greater than the porosity of the porous layer (not shown).

In alternative embodiments, the number of support members, support member spacing, and support member thickness can each be independently varied. The support members 208 can also be broken or segmented. The porous main body 210 is sized to have an outer diameter that is less than the inner diameter of the tube 102, thereby defining fluid retention channels between the outer surface of the porous main body 210 and the inner wall of the tube 102. The surfaces of the porous main body 210 between the support members 208 can be flat, curved or have another suitable geometry. In the example of FIG. 2A, the support members 208 and the main body 210 form a single structure. The porous main body 210 includes at least one pore.

FIG. 2B shows a cross-sectional view of the porous float from FIG. 2A taken along the line I-I. The porous float 104 may include a central area 212 that is in fluid communication with the pierceable segment 202 and the main body 210 to permit a fluid to flow through and out of the porous float 104. The central area 212 may include a porous material or may be a hollow space. The porous float 104 may be pre-filled with a fluid before being introduced into a tube; or, the porous float 104 may be empty and may filled with a fluid at some point in time after being introduced to a tube.

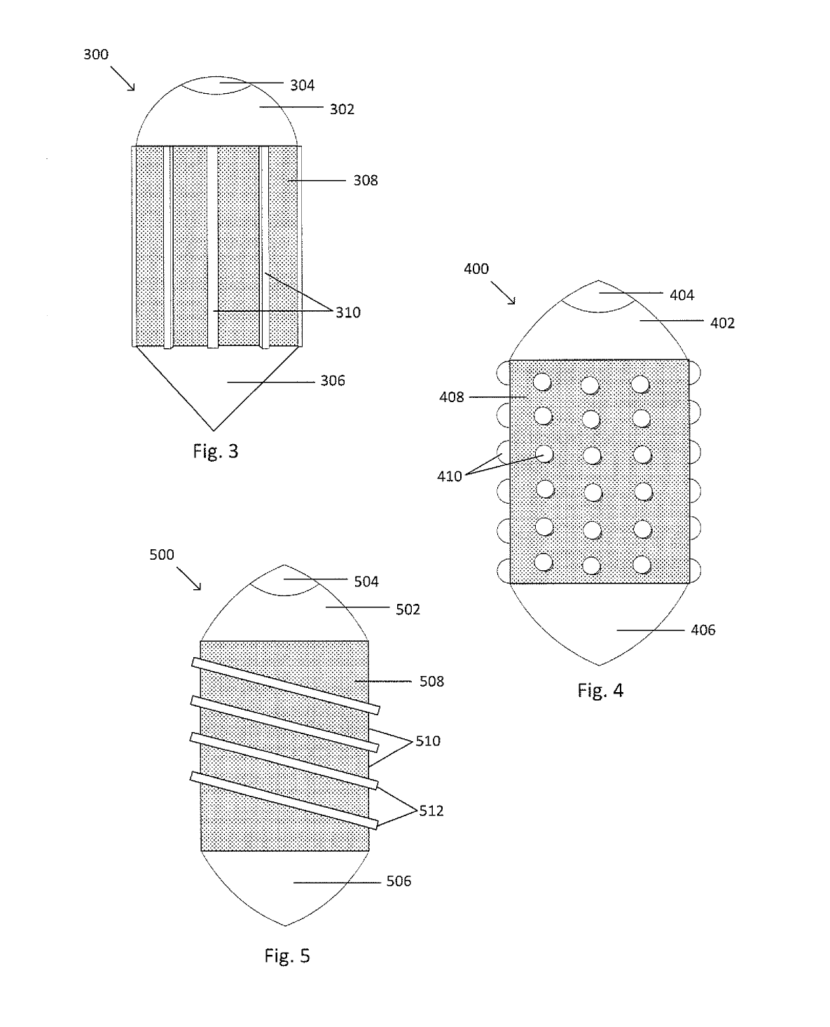

Embodiments include other types of geometric shapes for porous float end caps. FIG. 3 shows an isometric view of an example porous float 300 with a dome-shaped end cap 302 and a cone-shaped end cap 306. A porous main body 308 of the porous float 300 can include the same structural elements (i.e., support members) 310 as the porous float 104. A porous float can also include a teardrop-shaped end cap. The porous float end caps can include other geometric shapes and are not intended to be limited to the shapes described herein. The porous float 300 may also include a pierceable segment 304 and a central area (not shown), which may be hollow or filled with a porous material.

In other embodiments, the main body of the porous float 104 can include a variety of different support structures for separating target materials, supporting the tube wall, or directing the suspension fluid around the porous float during centrifugation. FIGS. 4 and 5 show examples of two different types of main body structural elements. Embodiments are not intended to be limited to these two examples. In FIG. 4, a porous main body 408 of a porous float 400 is similar to the porous float 104 except the porous main body 408 includes a number of protrusions 410 that provide support for the tube. In alternative embodiments, the number and pattern of protrusions can be varied. The porous float 400 may also include a pierceable segment 404 and a central area (not shown), which may be hollow or filled with a porous material. In FIG. 5, a porous main body 508 of a porous float 500 includes a single continuous helical structure or ridge 512 that spirals around the porous main body 508 creating a helical channel 510. In other embodiments, the helical ridge 512 can be rounded or broken or segmented to allow fluid to flow between adjacent turns of the helical ridge 512. In various embodiments, the helical ridge spacing and rib thickness can be independently varied. The porous float 500 may also include a pierceable segment 504 and a central area (not shown), which may be hollow or filled with a porous material.

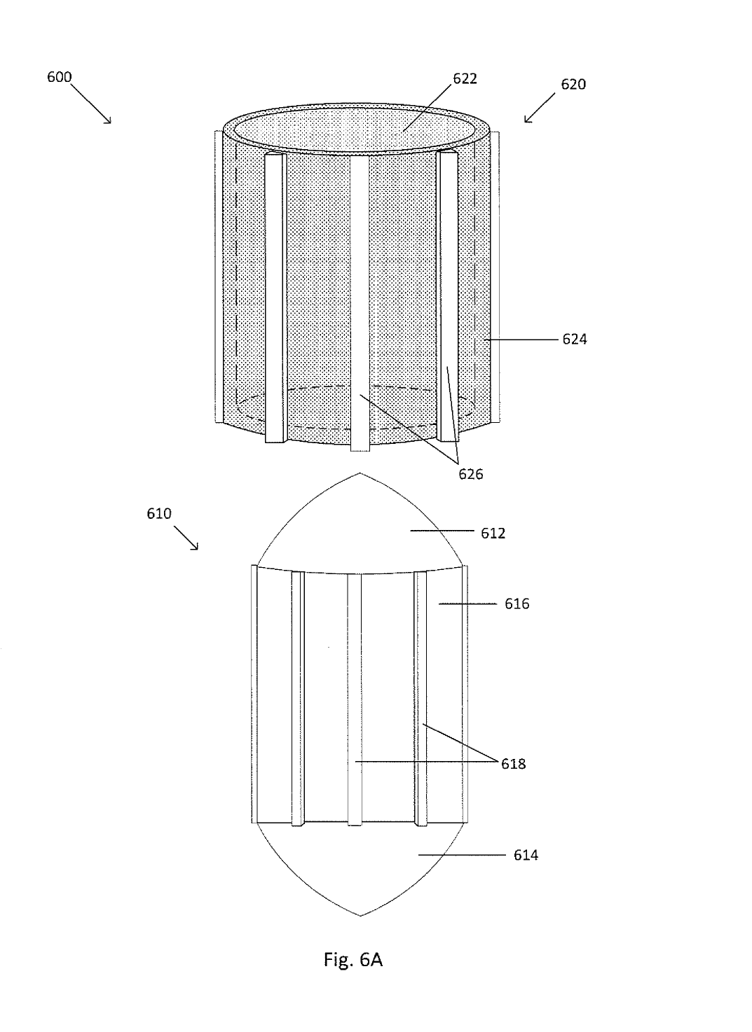

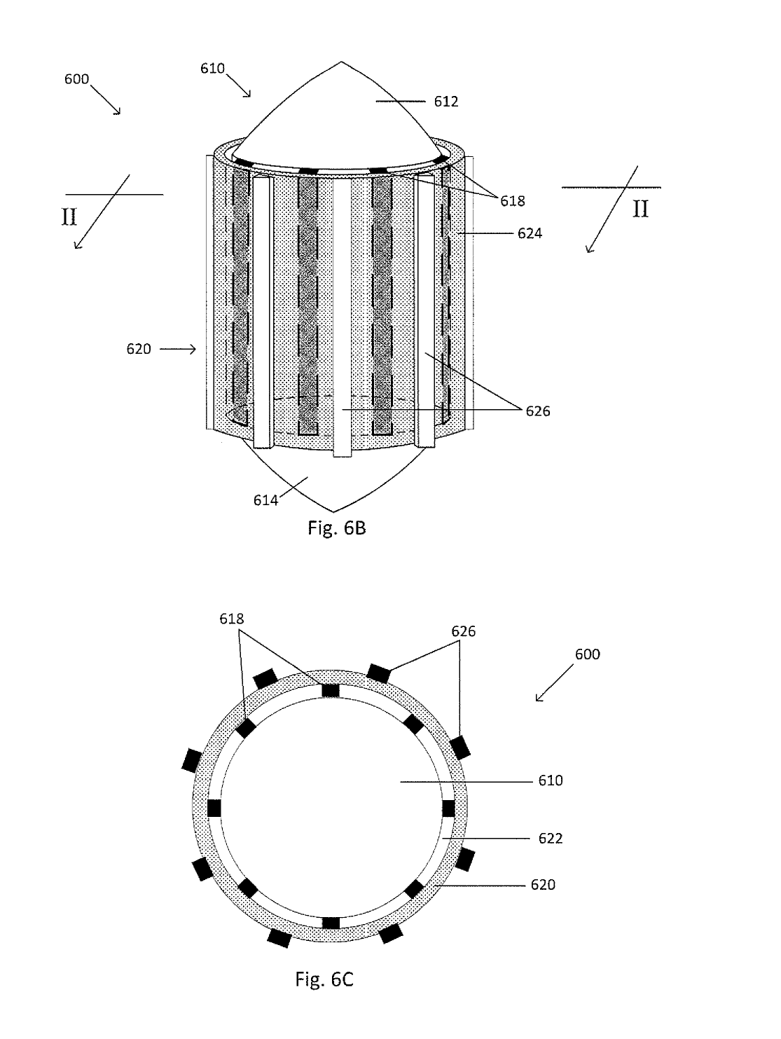

FIG. 6A shows an exploded view of a porous float 600. FIG. 6B shows an isometric view of the porous float 600. The porous float 600 includes a float 610 and a porous layer 620. The float 610 includes a main body 616, a top end cap 612, and a bottom end cap 614. The float 610 may also include float support members 618 radially spaced and axially oriented on the main body 616. When present, the float support members 618 provide support for the porous layer 620. The top end cap may be teardrop-shaped, dome-shaped, cone-shaped, or any other appropriate shape. The bottom end cap may be teardrop-shaped, dome-shaped, cone-shaped, or any other appropriate shape.

The porous layer 620, which may be removable from or permanently attached to the float 610, includes a hole 622, a porous main body 624, and layer support members 626 radially spaced and axially oriented on the porous main body 624. The hole 622 is configured to fit around the float 610. The layer support members 626 provide a sealing engagement with the inner wall of a tube.

FIG. 6C shows a cross-sectional view of the porous float 600 taken along the line II-II. The porous float 600 includes the float 610 and the porous layer 620. When the float 610 includes the float support members 618, the float support members 618 may provide support for the porous layer 620, such that when the porous layer 620 is placed over the float 610, a space is created between the float 610 and the porous layer 620. The space provides an area by which a fluid may be introduced into the porous float. The fluid may be introduced in the space, thereby allowing for the fluid to diffuse through the porous layer 620 and into other areas of a tube. When the float 610 does not include the float support members 618, the space may not be present and the float 610 and the porous layer 620 may be in contact. Alternatively, when the float 610 does not include the float support members 618, the space may be present by including a spacer between the float 610 and the porous layer 620. The spacer (not shown) is configured to create a space between the float 610 and the porous 620. The space can extend any length between the float 610 and the porous layer 620. The space may also be non-continuous in either one or both of the circumferential or longitudinal directions.

The top end cap may be teardrop-shaped, dome-shaped, cone-shaped, or any other appropriate shape. The bottom end cap may be teardrop-shaped, dome-shaped, cone-shaped, or any other appropriate shape. The float support members and the layer support members may also be a helical ridge which creates a helical groove or may be protrusions.

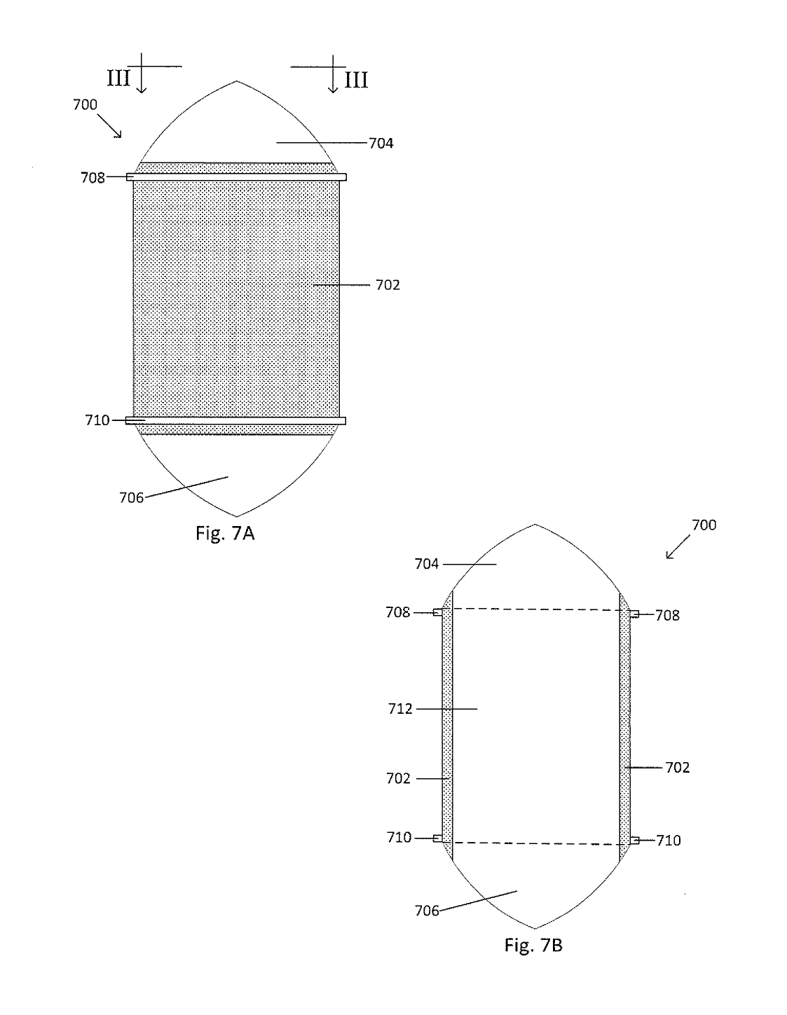

FIG. 7A shows an isometric view of a porous float 700. FIG. 7B shows cross-section view of the porous float 700 along the line III-III. The porous float 700 includes a main body 712 and a porous layer 702, which includes at least one pore. The porous float 700 includes a teardrop-shaped top end cap 704 and a teardrop-shaped bottom end cap 706. The porous float 700 may also include a top support member 708, which extends circumferentially around an upper portion of the main body 712 or porous layer 702, and a bottom support member 710, which extends circumferentially around a lower portion of the main body 712 or porous layer 702. The porous layer 712 surrounds an outer surface of the main body 712. The porous layer 702 and the main body 712 may be a singular structure, or the porous layer 702 may be wrapped around the main body 712, and thereby being different structures. The porous layer 702 may extend underneath the top support member 708 to a bottom portion of the top end cap 704; the porous layer 702 may extend underneath the bottom support member 710 to a top portion of the bottom end cap 706; or, the porous layer 702 may extend from a bottom of the top support member 708 to a top of the bottom support member 710. The porous layer 702 can surround the entire main body 712, a portion of the main body 712, or a plurality of portions of the main body 712. The porous float 700 may also include at least one support member (not shown) between the top and bottom support members, the at least one support member (not shown) may be vertical, be horizontal, be protrusions, be at least one helical ridge, or any appropriate support member shape or configuration. The top and bottom end caps 704, 706 may include a portion of the porous layer 702 or may include at least one porous segment including the same porous material as the porous layer 702 and in fluid communication with the porous layer 702. The top support member 708 and the bottom support member 710 may be extensions of the porous layer 702, which extend horizontally out from the porous layer 702. Alternatively, the top support member 708 and the bottom support member 710 may be extensions of the main body 712 or top and bottom end caps 704, 706, which extend horizontally out from the main body 712 or the top and bottom end caps 704, 706. The porous layer 702 can be layered over the horizontal extensions to further augment the top and bottom support members 708, 710. The porous layer 702 can also be layered over the at least one other support member for augmentation. The porous float 700 may also include a coating (not shown), such as parylene, which at least partially covers the porous float 700 and which may be made porous, at least in areas between the top and bottom support members 708, 710 through machining, through the use of a laser, or the like.

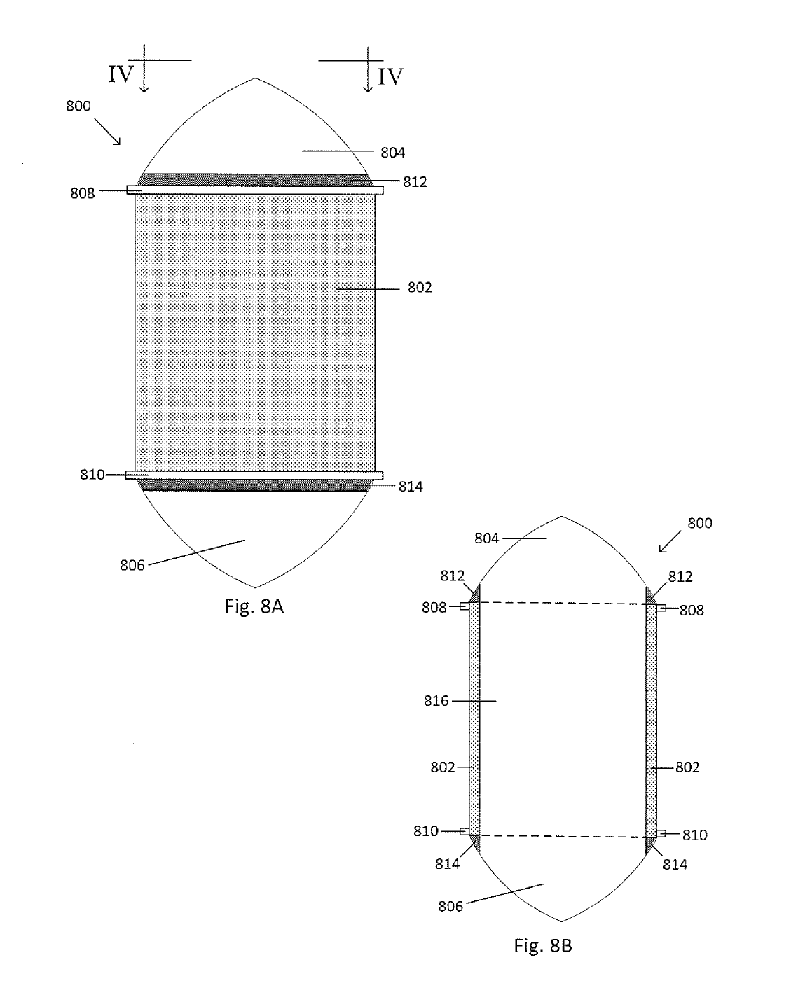

FIG. 8A shows an isometric view of a porous float 800. FIG. 8B shows cross-section view of the porous float 800 along the line IV-IV. The porous float 800 includes a main body 816 and a porous layer 802, which includes at least one pore. The porous float 800 includes a teardrop-shaped top end cap 804 and a teardrop-shaped bottom end cap 806. The porous float 800 may also include a top support member 808, which extends circumferentially around an upper portion of the main body 816 or porous layer 802, and a bottom support member 810, which extends circumferentially around a lower portion of the main body 816 or porous layer 802. The porous layer 802 surrounds an outer surface of the main body 816. The porous layer 802 and the main body 816 may be a singular structure, or the porous layer 802 may be wrapped around the main body 816, and thereby being different structures. The porous layer 802 may extend from a bottom of the top support member 808 to a top of the bottom support member 810. The top and bottom end caps 804, 806 may include a cap gap 812, 814 which is a different porous material than the porous layer 802, though still in fluid communication with the porous layer 802. The cap gap 812, 814 may be segmented, may an individual opening, or may be a continuous ring around at least one of the end caps 804, 806. The porous layer 802 can surround the entire main body 802, a portion of the main body 816, or a plurality of portions of the main body 816. The porous float 800 may also include at least one support member (not shown) between the top and bottom support members, the at least one support member (not shown) may be vertical, be horizontal, be protrusions, be at least one helical ridge, or any appropriate support member shape or configuration. The top support member 808 and the bottom support member 810 may be extensions of the porous layer 802, which extend horizontally out from the porous layer 802. Alternatively, the top support member 808 and the bottom support member 810 may be extensions of the main body 816 or top and bottom end caps 804, 806, which extend horizontally out from the main body 816 or the top and bottom end caps 804, 806. The porous layer 802 can be layered over the horizontal extensions to further augment the top and bottom support members 808, 810. The porous layer 802 can also be layered over the at least one other support member for augmentation. The porous float 800 may also include a coating (not shown), such as parylene, which at least partially covers the porous float 800 and which may be made porous, at least in areas between the top and bottom support members 808, 810 through machining, through the use of a laser, or the like.

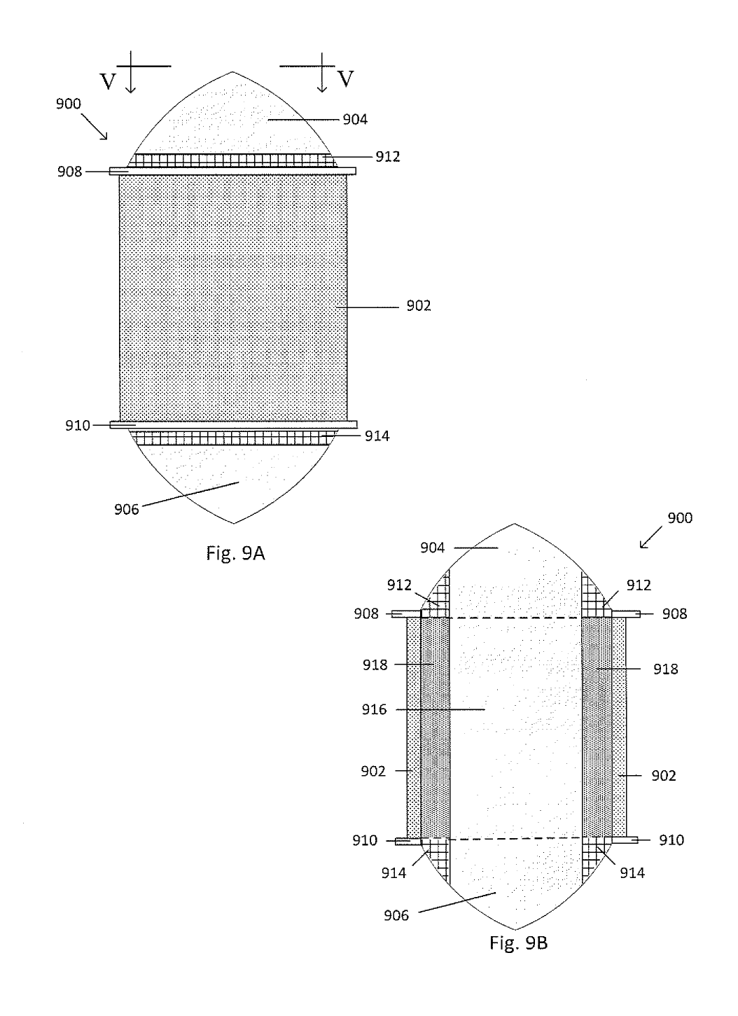

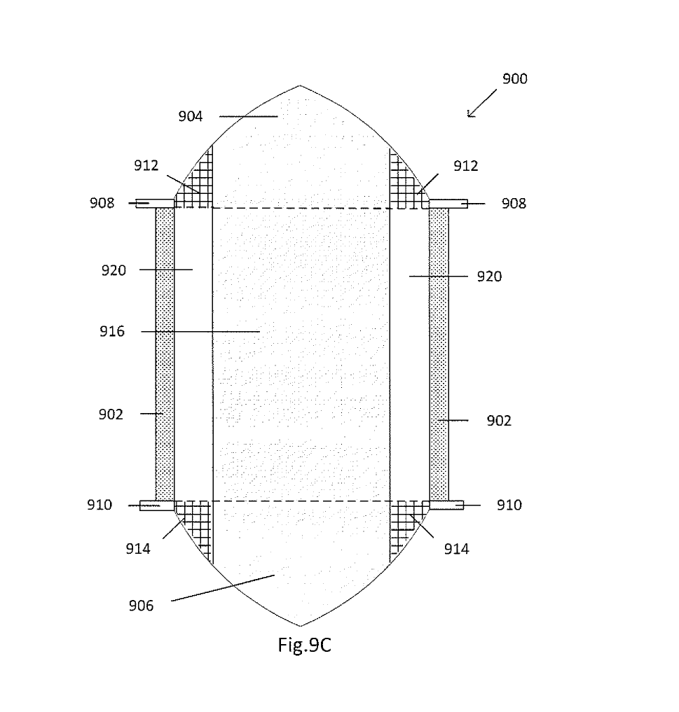

FIG. 9A shows an isometric view of a porous float 900. FIG. 9B shows cross-section view of the porous float 900 along the line V-V. The porous float 900 includes a main body 916 and an intermediary layer 918. The intermediary layer 918 may be porous. The porosity of the intermediary layer 918 may be greater than the porosity of a porous layer 902. The porous float 900 includes a teardrop-shaped top end cap 904 and a teardrop-shaped bottom end cap 906. The top end cap may be teardrop-shaped, dome-shaped, cone-shaped, or any other appropriate shape. The bottom end cap may be teardrop-shaped, dome-shaped, cone-shaped, or any other appropriate shape. The porous float 900 may also include the top support member 908, which extends circumferentially around an upper portion of the main body 916 or intermediary layer 918, and the bottom support member 910, which extends circumferentially around a lower portion of the main body 916 or intermediary layer 918. The porous float 900 may also include a coating (not shown), such as parylene, which at least partially covers the porous float 900 and which may be made porous, at least in areas between the top and bottom support members 908, 910 through machining, through the use of a laser, or the like.

The intermediary layer 918 surrounds an outer surface of the main body 916. The intermediary layer 918 may extend underneath the top support member 908 to a bottom portion of the top end cap 904; the intermediary layer 918 may extend underneath the bottom support member 910 to a top portion of the bottom end cap 906; or, the intermediary layer 918 may extend from a bottom of the top support member 908 to a top of the bottom support member 910. The top and bottom end caps 904, 906 may include at least one cap gap 912, 914 which may be filled with the same porous material as the porous layer, a different porous material than the intermediary layer 918, though still in fluid communication with the intermediary layer 918, or may be empty and therefore an open channel to permit fluid communication between the open channel and the intermediary layer 918. The at least one cap gap 912, 914 may be segmented, may be an individual opening, or may be a continuous ring around the respective end cap 904, 906. The intermediary layer 918 can surround the entire main body 916, a portion of the main body 916, or a plurality of portions of the main body 916. The porous float 900 also includes the porous layer 902. The porous layer 902 surrounds the intermediary layer 918. The porous layer 902, intermediary layer 918, and the main body 916 may be a singular structure; the intermediary layer 918 and. the main body 916 may be a singular structure, with the porous layer wrapped around the intermediary layer 918; or the porous layer 902, the intermediary layer 918 and the main body 916 may all be different structures. The porous float 900 may also include at least one support member (not shown) between the top and bottom support members 908, 910, the at least one support member (not shown) may be vertical, be horizontal, be protrusions, be at least one helical ridge, or any appropriate support member shape or configuration. The top support member 908 and the bottom support member 910 may be extensions of the porous layer 902, the at least one cap gap 912, 914, or the intermediary layer 918, which extend horizontally out from each respective layer and each other respective layer may be used to augment the top and bottom support members 908, 910. Alternatively, the top support member 908 and the bottom support member 910 may be extensions of the main body 916, which extend horizontally out from the main body 916. The porous layer 902 or intermediary layer 918 can be layered over the horizontal extensions to further augment the top and bottom support members 908, 910. The porous layer 902 can also be layered over the at least one other support member (not shown) for augmentation.

As seen in FIG. 9C, there may be a space 920 between the porous layer 902 and the main body 916. When the space 920 is present, the porous layer 902 still surrounds the space 920. At least one spacer (not shown) may be used to maintain the spacing of the space 920, though the spacer need be present, as the porous layer 902 may be fit and held between the top and bottom supper members 908, 910, whether through a pressure fit, an adhesive, or the like.

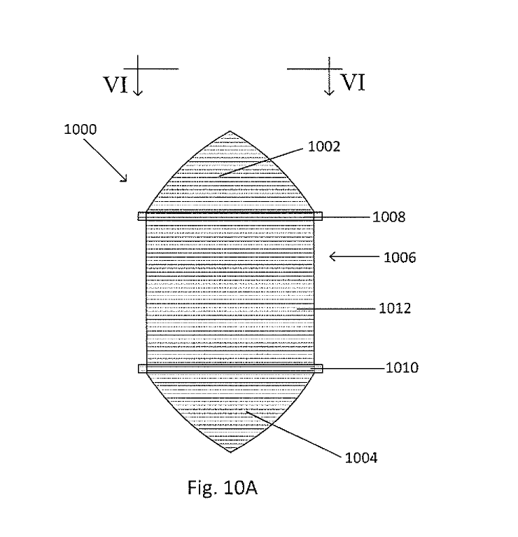

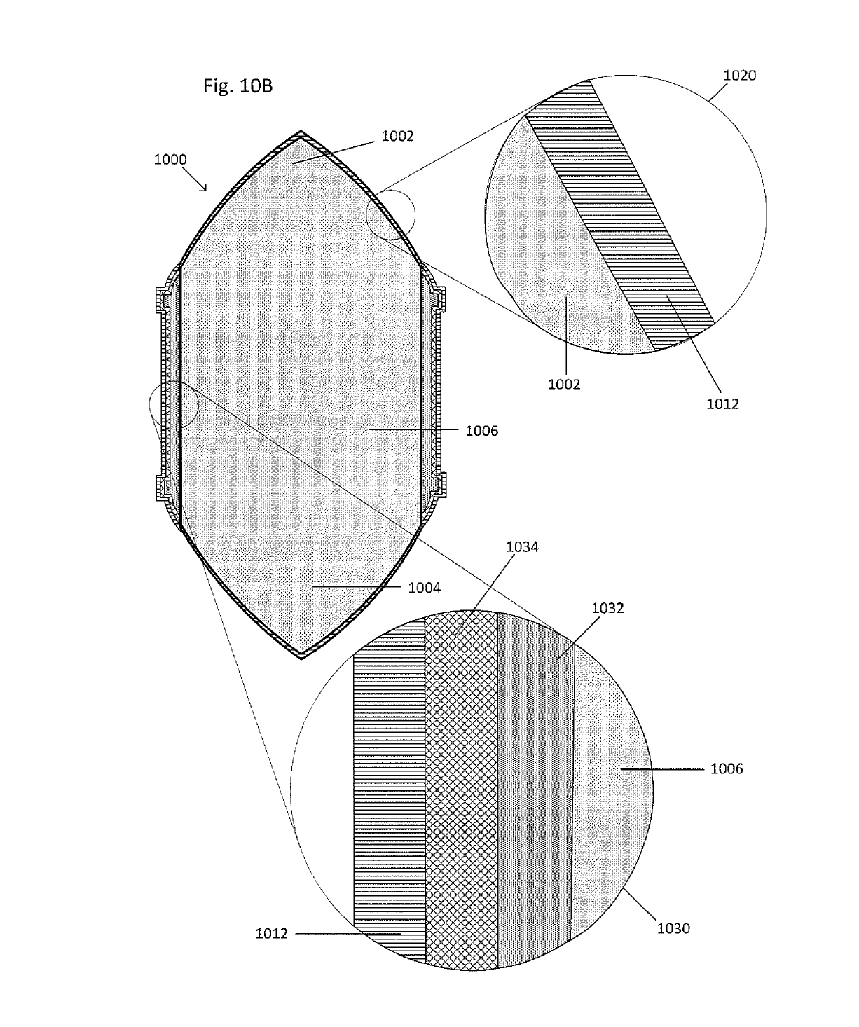

FIG. 10A shows an isometric view of a porous float 1000. The porous float 1000 includes a main body 1006 and a coating 1012. The porous float 1000 includes a teardrop-shaped top end cap 1002 and a teardrop-shaped bottom end cap 1004. The top end cap may be teardrop-shaped, dome-shaped, cone-shaped, or any other appropriate shape. The bottom end cap may be teardrop-shaped, dome-shaped, cone-shaped, or any other appropriate shape. The porous float 1000 may also include a top support member 1008, which extends circumferentially around an upper portion of the main body 1006, and a bottom support member 1010, which extends circumferentially around a lower portion of the main body 1006. The porous float 1000 may also include at least one support member (not shown) between the top and bottom support members, the at least one support member (not shown) may be vertical, be horizontal, be protrusions, be at least one helical ridge, or any appropriate support member shape or configuration.

FIG. 10B shows a cross-sectional view of the porous float 100 along line VI-VI. The porous float 1000 includes a porous layer 1032 and the coating 1012. The porous layer 1032 surrounds an outer surface of the main body 1006. The top support member 1008 and the bottom support member 1010 may be extensions of the porous layer 1032, which extend horizontally out from the porous layer 1032. The coating 1012 can be layered over the horizontal extensions to further augment the top and bottom support members 1008, 1010. Alternatively, the top support member 1008 and the bottom support member 1010 may be extensions of the main body 1006, which extend horizontally out from the main body 1006. The porous layer 1032 and the coating 1012 can be layered over the horizontal extensions to further augment the top and bottom support members 1008, 1010.

The porous layer 1032 may extend underneath the top support member 1008 to a bottom portion of the top end cap 1002; the porous layer 1032 may extend underneath the bottom support member 1010 to a top portion of the bottom end cap 1004; or, the porous layer 1032 may extend from a bottom of the top support member 1008 to a top of the bottom support member 1010. The porous layer 1032 can surround the entire main body 1006, a portion of the main body 1006, or a plurality of portions of the main body 1006. The porous float 1000 may also include at least one support member (not shown) between the top and bottom support members 1008, 1010, the at least one support member (not shown) may be vertical, be horizontal, be protrusions, be at least one helical ridge, or any appropriate support member shape or configuration. The top and bottom end caps 1002, 1004 may include a portion of the porous layer 1032. The coating 1012 may also be porous. The coating 1012 may be a porous material or may be a material, such as parylene, which is made porous through machining, through the use of a laser, or the like.

The porous float 1000 may also include a reflective layer 1034. The reflective layer 1034 can be layered in between the porous layer 1032 and the coating 1012; or, the reflective layer 1034 may be layered on top of at least a portion of the coating 1012. The reflective layer 1034 can reflect light, which includes electromagnetic radiation in the visible portion of the electromagnetic spectrum and radiation in the ultraviolet and infrared portions of the electromagnetic spectrum. The reflective layer 1034 can be made to be reflective by combining the rigid organic and inorganic materials listed below with a white pigment during fabrication; or, can be made to be reflective by adding a highly reflective or white pigment to the material composition. The reflective layer 1034 can have a glossy or matte finish. Examples of white plastics that can be used include, but are not limited to, white Delrin®, moisture resistance polyester, wear-resistant slippery cast nylon 6, impact-resistant slippery UHMW polyethylene, opaque white polypropylene, rigid HDPE polyethylene, UV resistant VHMW polyethylene, acrylic PVC, flame-retardant polypropylene, moisture-resistant LDPE polyethylene, lightweight rigid PVC foam, structural fiberglass, and white polystyrene. The reflective layer 1034 can be made to be reflective by applying a reflective coating. For example, the reflective coating can be a reflective paint, such as white paint, paint with reflective particles or ceramic beads or a reflective polymer. The paint can have a glossy or matte finish. The reflective layer 1034 can be made to be reflective by plating a reflective material on the reflective layer 1034. For example, the plating can be a shiny reflective metal, ceramic, or a mirror. Suitable reflective metals include, but are not limited to, gold, silver, aluminum, tin, copper, bronze, chromium, cobalt, nickel, palladium, platinum, manganese, zinc, titanium, niobium, molybdenum, tungsten, stainless steel, or a suitable metalloid. The reflective layer 1034 can be made to be reflective by incorporating reflective objects or particles. The reflective layer 1034 may also be porous. The reflective layer 1034 may be a porous material or may be a material, such as parylene, which is made porous through machining, through the use of a laser, or the like.

At least one pore may extend through the coating 1012, the reflective layer 1034, and the porous layer 1032, thereby stretching from a space between the porous float 1000 and the tube 102 to the main body 1006 of the porous float 1000. Additionally, the outermost layer (i.e. the coating or the reflective layer, depending on the arrangement of the layers) may be non-porous at portions on or around the top and bottom support members 1008, 1010; the remaining portions of the outermost layer, such as those between the top and bottom support members 1008, 1010 and on the top and bottom end caps 1002, 1004. The outermost layer of the porous float 1000 may also include an overlay, such a chemical or adhesive, to attract and/or hold a target analyte.

A porous layer, porous intermediary layer, or porous main body may include at least one pore. The at least one pore may be sized to prevent a target analyte from passing through, thereby only allowing at least one molecule, such as a molecule of a suspension or a solute molecule in a solvent, to pass through, such as by passive (i.e. diffusion) or active (i.e. a pressure gradient) action; or, the at least one pore may be sized to permit a target analyte to pass through. The number of pores, pore spacing, and pore size can be varied. When a plurality of layers is present, each layer may have pores which are different in size, number and/or shape than the pores of a different layer. Within a given layer and when a plurality of pores is present, the size, number and/or shape may be different from pore to pore. The at least one pore may be any appropriate shape, including, but not limited to, circular, elliptical, triangular, rectangular, quadrilateral, or polyhedral. The pore size may be less than 1 μm, equal to 1 μm, or greater than 1 μm. The support members may also be porous, including at least one pore.

A porous float can be composed of a variety of different materials including, but not limited to, metals, including, but not limited to, aluminum, brass, gold, silver, tin, copper, bronze, chromium, cobalt, nickel, lead, iron, steel, manganese, zinc, neodymium, and combinations thereof; rigid organic or inorganic materials; ferrous plastics; sintered metal; machined metal; and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoro ethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer, butyl rubber, ethylene propylene diene monomer, others, and combinations thereof.

The end caps may be manufactured as a portion of the main body, thereby being one singular structure, by machining, injection molding, additive techniques, or the like; or, the end caps may be connected to the main body by a press fit, an adhesive, a screw, any other appropriate method by which to hold at least two pieces together, or combinations thereof

A porous float can be made to be reflective. A porous layer or a main body of the porous float may be made to reflective. The porous layer or main body can be made to be reflective by combining the rigid organic and inorganic materials listed above with a white pigment during fabrication; or, can be made to be reflective by adding a highly reflective or white pigment to the material composition. The porous layer or main body can have a glossy or matte finish. Examples of white plastics that can be used include, but are not limited to, white Delrin®, moisture resistance polyester, wear-resistant slippery cast nylon 6, impact-resistant slippery UHMW polyethylene, opaque white polypropylene, rigid HDPE polyethylene, UV resistant VHMW polyethylene, acrylic PVC, flame-retardant polypropylene, moisture-resistant LDPE polyethylene, lightweight rigid PVC foam, structural fiberglass, and white polystyrene. A porous layer or main body can be made to be reflective by applying a reflective coating. For example, the coating can be a reflective paint, such as white paint, paint with reflective particles or ceramic beads or a reflective polymer. The paint can have a glossy or matte finish. The porous layer or main body can be made to be reflective by plating a reflective material on the porous layer. For example, the plating can be a shiny reflective metal, ceramic, or a mirror. Suitable reflective metals include, but are not limited to, gold, silver, aluminum, tin, copper, bronze, chromium, cobalt, nickel, palladium, platinum, manganese, zinc, titanium, niobium, molybdenum, tungsten, stainless steel, or a suitable metalloid. The porous layer or main body can be made to be reflective by incorporating reflective objects or particles.

A porous layer can also include an overlay to attract and/or hold the target analyte. The overlay may be any material which may either attract the target analyte and form a chemical bond with the target analyte, cause the target analyte to adhere to the porous layer (i.e. an adhesive), or both. The overlay, located on an outer surface of the porous layer, may completely cover the outer surface or may only cover portions of the outer surface. The different types of overlays are designed to increase the affinity of the porous layer for the cells through different mechanisms. In the instance in which the overlay attracts the target analyte and forms a chemical bond with the target analyte, the bond, and related attraction, may be covalent, ionic, dipole-dipole interactions, London dispersion forces, van der Waals forces, or hydrogen bonding. The overlay may include a primary antibody that binds to biomarkers, including but not limited to, EpCAM, AMACR, Androgen receptor, CD146, CD227, CD235, CD24, CD30, CD44, CD45, CD56, CD71, CD105, CD324, CD325, MUC1, CEA, cMET, EGFR, Folate receptor, HER2, Mammaglobin, PSMA, or combinations thereof. In the case in which the overlay is an adhesive, including any variation of Mytilus edulis foot protein (“Mefp”), biopolymers, or polyphenolic proteins (including those polyphenolic proteins containing L-DOPA), the target analyte adheres to the porous layer.

The overlay may also be any material which is convertible or releasable to hold the target analyte to the removable layer (i.e. photo-convertible adhesive, photolysible particle). The material may be converted or released after the system undergoes density-based based separation. When the overlay comprises a convertible material, then the overlay is converted by the energy from a given source to form chemical bonds with the cell. When the overlay comprises a releasable material, then a secondary material may be released from the releasable material or the releasable material itself may be released from the outer surface of the removable layer, such that the secondary material or the releasable material form chemical bonds with the target analyte. The secondary material or releasable material may include fixing agents (i.e. formaldehyde, formalin, paraformaldehyde, or glutaraldehyde), detergents (i.e. saponin, polyoxyethylene, digitonin, octyl β-glucoside, octyl β-thioglucoside, 1-S-octyl-β-D-thioglucopyrano side, CHAPS, CHAPSO, (1,1,3,3-Tetramethylbutyl)phenyl-polyethylene glycol or octylphenol ethylene oxide), or staining agents (i.e. fluorescently-labeled antibodies, Pap stain, Giemsa stain, or hematoxylin and eosin stains). The energy from a given source may be in forms such as light, heat, ultrasound, or electromagnetism, such as radio waves and microwaves. For example, the porous layer may be coated with a photo-convertible material. A light source having a wavelength ranging from about 250 nm to about 1200 nm may be used to convert the photo-convertible material. An ultraviolet light source, such as a wavelength of approximately 355 nm, may be used to induce a chemical reaction in the photo-convertible material, thereby creating a covalent bond and causing adhesion of the target analytes to the porous layer.

A porous layer can also be functionalized using a self-assembled monolayer comprising a head, a tail, and a functional group. The head reacts with and attaches to the porous layer, and may be any chemical having a high affinity for the porous layer. For example, sulfur has a high affinity for metals. The tail can be a carbon backbone that connects the head to the functional group and may be any suitable length and may or may not be branched. The functional group is selected based on the appropriate functionality or reaction desired. Examples of self-assembled monolayers include alkanethiols for metals and silanes for nonmetallic oxides. After the porous layer has been functionalized, materials may be added the suspension to provide better capture of the target analytes. The materials include Mytilus edulis foot protein (“Mefp”); biopolymers; polyphenolic proteins (including those polyphenolic proteins containing L-DOPA); chemo-attractant molecules, such as epidermal growth factor (“EGF”) or vascular endothelial growth factor (“VEGF”); an extracellular matrix protein (“ECM”); maleic anhydride; maleimide activated sulfa-hydryl groups, poly-L-lysine; poly-D-lysine; streptavidin; neutravidin; protein A; protein G; protein A/G, protein L; biotin; glutathione; antibodies; recombinant antibodies: aptamers; RGD-peptides; fibronectin; collagen; elastin; fibrillin; laminin; or proteoglycans.

Chemo-attractant molecules are ones which will elicit a chemotaxis response from the target analyte, whereby the target analyte is attracted to the chemicals.

Chemotaxis is an active movement of the target analyte due to a chemical or chemicals present in the environment. The EGF, VEGF, chemo-attractant molecule, or ECM may be used as a layer, either alone or layered in conjunction with a material discussed above. Furthermore, the EGF, VEGF, chemo-attractant molecule, or ECM may be mixed together as one layer on the outer surface of the porous layer. The EGF, VEGF, chemo-attractant molecule, or ECM, when used in combination with one of the other overlays discussed above, may be a sub-layer in which it is layered between the porous layer and the other overlay or may be the overlay where the one or the other materials discussed above is the sub-layer. The overlay may also be a mixture of the EGF, VEGF, chemo-attractant molecule, or ECM with one of the materials discussed above. The overlay of EGF, VEGF, chemo-attractant molecule, or ECM will cause the target analyte to migrate towards the porous layer, where the target analyte can then be captured and held by one of the other overlays discussed above. When the overlay of EGF, VEGF, chemo-attractant molecule, or ECM is used separately, it will be the only overlay and will simply be more attractive to the target analyte than other surfaces within the tube and porous layer system.

### Methods for Using Tube and Porous Float Systems

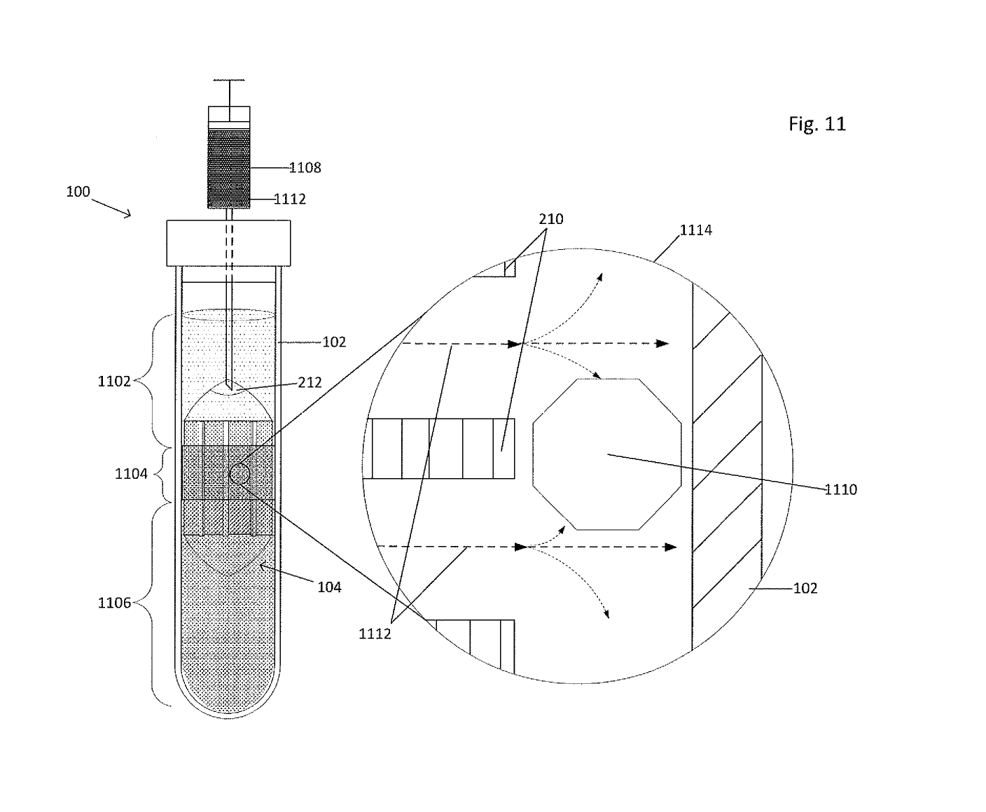

FIG. 11 shows an isometric view of a tube and porous float system 100 having undergone centrifugation. A snapshot 1114 is also included which shows the interaction between a solution 1112 and a target analyte 1110. Suppose, for example, the suspension includes three fractions. During centrifugation, the suspension may be divided into and settle into the three fractions, including a densest fraction 1106, a medium density fraction 1104, and a least dense fraction 1102. The target analyte 1110 may be found in the medium-density fraction 1104. The porous float 104 may have a density substantially similar to that of the target analyte 1110, so that the porous float 104 and the target analyte 1110 align properly within the tube 102.

A fluid introducer 1108, such as a syringe, pump, or the like, may be used to introduce a solution 1112 into the porous float 104 through a pierceable segment 202. The solution 1112, passing out of the fluid introducer 1108, can flow into the porous float 104 and then into a space between the porous float 104 and the tube 102 by leaving the porous float 104 through at least one pore 210. The solution 1112, upon exiting the porous float 104, may diffuse throughout at least the medium-density fraction 1104 and interact with the target analyte 1110.

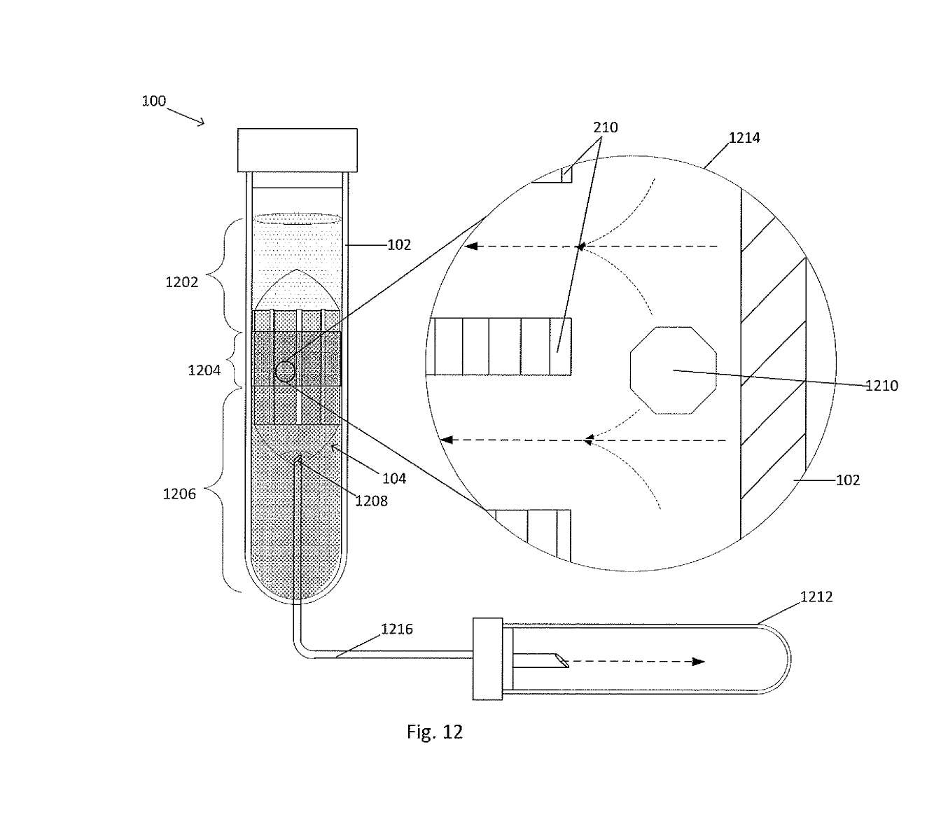

FIG. 12 shows an isometric view of a tube and porous float system 100 having undergone centrifugation. A snapshot 1214 is also included which shows the interaction between a vacuum 1212 and a target analyte 1210. Suppose, for example, the suspension includes three fractions. During centrifugation, the suspension may be divided into and settle into the three fractions, including a densest fraction 1206, a medium density fraction 1204, and a least dense fraction 1202. The target analyte 1210 may be found in the medium-density fraction 1204. The porous float 104 may have a density substantially similar to that of the target analyte 1210, so that the porous float 104 and the target analyte 1210 align properly within the tube 102.

A needle 1208 may be used to introduce a vacuum into the porous float 104 through a pierceable segment 202. The vacuum, created by a vacuum tube 1212, pump, syringe, or the like, connected to the needle 1208 via tubing 1216, can pull the target analyte 1210 into the porous float 104 through a pore 210 and then into the vacuum tube 1212 or pump.

Alternatively, the solution may be added to the tube and may flow through the pores via capillary action.

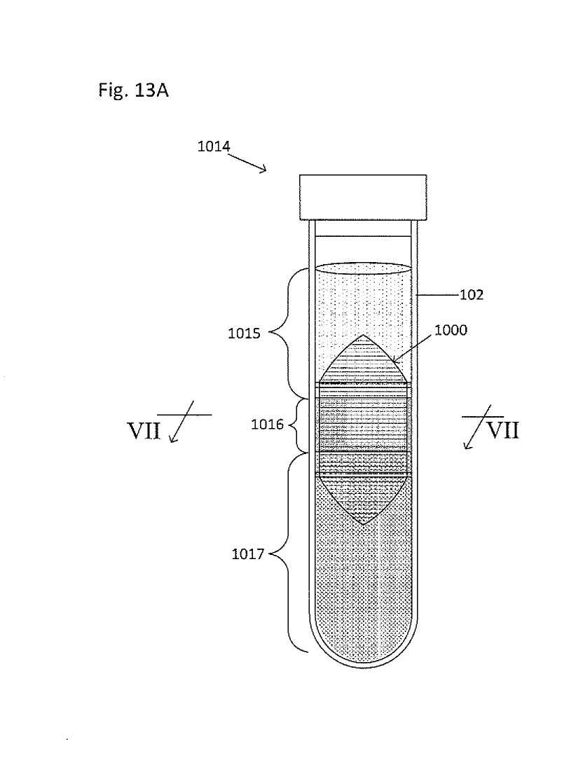

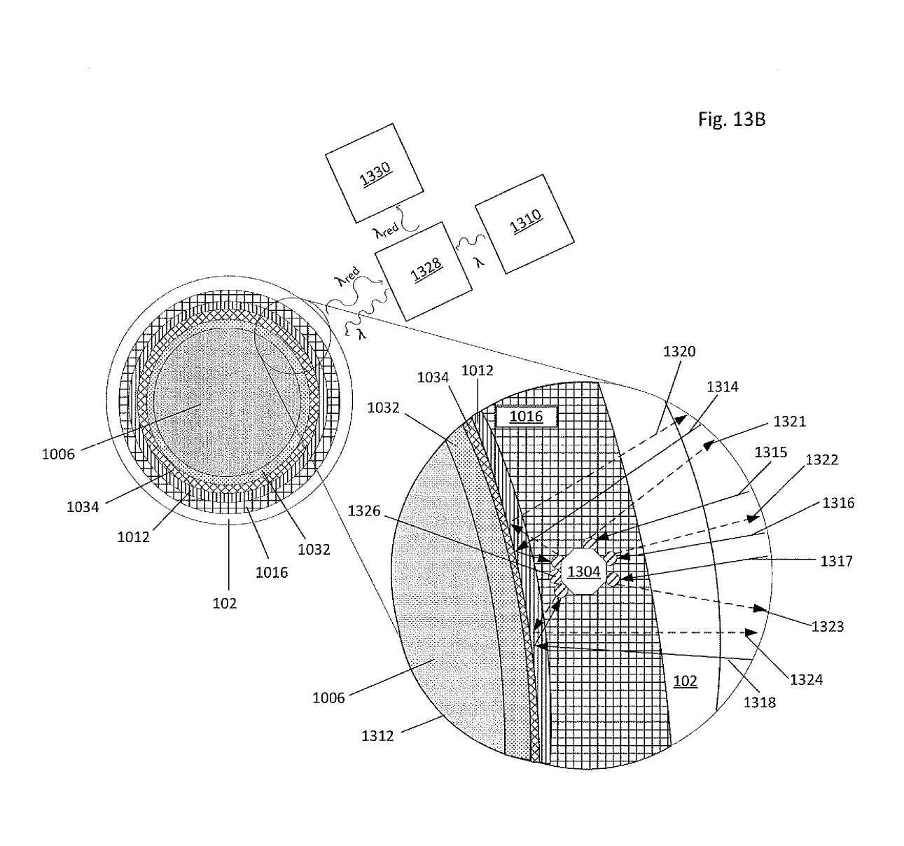

FIG. 13A shows an isometric view of a tube and porous float system 1014 having undergone centrifugation. The reflective surface of a reflective layer or coating of a porous float can increase the intensity of light emitted from fluorescent probes. FIG. 13B shows a cross-sectional view of the system 1014 along the line VII-VII shown in FIG. 13A. In the example of FIG. 13B, the cross-sectional view reveals that the main body 1006 of the porous float 1000 includes the reflective layer 1034. A multichannel light source 1310 illuminates a medium-density fraction 1016 in a space between an inner wall of the tube 102 and the outermost-layer of the porous float 1000, which, in this instance, is the coating 1012 with excitation light to excite fluorescent probes attached to target material particles. The excitation light emitted by the multichannel light source 1310 passes through an objective 1328 to focus the excitation light on particular area. FIG. 13B includes a magnified view 1312 of a portion of the channel. Octagon 1304 represents a target analyte and smaller shaded circles, such as circle 1326, represent six fluorescent probes attached to the target analyte 1304 via ligands. Solid-line directional arrows 1314-1318 represent rays of excitation light associated with a channel output from the light source 1310. As shown in FIG. 13B, rays 1315-1317 pass through the tube 102 to illuminate the fluorescent probes facing the tube 102. Dashed-line directional arrows 1321-1323 represent rays of light emitted from the fluorescent probes that face the tube 102. Rays 1314 and 1318 represent excitation light that is reflected off of the reflective layer 1034 to illuminate fluorescent probes that face the float 1000. Dashed-line directional arrows 1320 and 1324 represent rays of excitation light emitted from the fluorescent probes that face the float 1000.

Note that without the reflective layer 1034, much of the light represented by the rays 1314 and 1318 is absorbed by the float 1000 and is not available to excite the fluorescent probes that face the float 1000. In the example of FIG. 13B, the light emitted from the fluorescent probes that face the float 1000 is also reflected from the reflective layer 1032 back to the objective 1328 and the sent to a detector 1330, such as a charge-coupled device (“CCD”). The light emitted from the fluorescent probes that face the float 1000 adds to the intensity of the light emitted from the fluorescent probes that face the tube 102. As a result, images of the target analyte 1304 appear brighter than the target analyte 1304 would otherwise appear with a dark colored or non-reflective float. Note also that because the excitation light and the emitted light are not absorbed by the porous float 1000, the porous float 1000 may not heat up and expand. Additionally, because the excitation light and the emitted light are not absorbed by the porous float 1000, the porous float 1000 may not transfer heat to the surrounding fluid, thereby preventing expansion and/or movement of the liquid. As a result, the target analyte 1304 is less likely to shift, making it easier to identify the location of the target analyte 1304 and the same target analyte 1304 can be relocated when the target material is illuminated a second time.

In order to identify and determine the presence of a target analyte in a suspension, target analyte particles can be tagged with fluorescent probes. After centrifugation, the tube is illuminated with light that induces photon emission from the fluorescent probes. The fluorescent light can be used to confirm the presence, characteristics, and/or identity of the target analyte. The fluorescent molecules are conjugated with molecules or other particles that bind specifically to the target analyte particles. The fluorescent molecules emit light of a known range of wavelengths, depending of the particular fluorescent molecule, within the electromagnetic spectrum when an appropriate stimulus is applied. As described above, the float has a density selected to position the float at approximately the same level as the target analytes when the tube, float, and suspension are centrifuged together. After centrifugation, the target analytes are located between the outer surface of the float and the inner wall of the tube and the fluorescent molecules fluoresce when an appropriate stimulus is applied.

The target analyte may be collected, and once collected, the target analyte may be analyzed using any appropriate analysis method or technique, though more specifically intracellular analysis including intracellular protein labeling; nucleic acid analysis, including, but not limited to, protein or nucleic acid microarrays; fluorescent in situ hybridization (“FISH”—a tool for analyzing DNA and/or RNA, such as gene copy number changes); or branched DNA (“bDNA”—a tool for analyzing DNA and/or RNA, such as mRNA expression levels) analysis. These techniques require fixation, permeabilization, and isolation of the target analyte prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erkl/2, Erk1/2, P38 MAPK, Vimentin, ER, PgR, PI3K, pFAK, KRAS, ALKH1, Twist1, Snail1, ZEB1, Slug, Ki-67, M30, MAGEA3, phosphorylated receptor kinases, modified histones, chromatin-associated proteins, and MAGE. To fix, permeabilize, or label, fixing agents (such as formaldehyde, formalin, methanol, acetone, paraformaldehyde, or glutaraldehyde), detergents (such as saponin, polyoxyethylene, digitonin, octyl β-glucoside, octyl β-thioglucoside, 1-S-octyl-β-D-thioglucopyranoside, polysorbate-20, CHAPS, CHAPSO, (1,1,3,3-Tetramethylbutyl)phenyl-polyethylene glycol or octylphenol ethylene oxide), or labeling agents (such as fluorescently-labeled antibodies, Pap stain, Giemsa stain, or hematoxylin and eosin stain) may be used.

It should be understood that the method and system described and discussed herein may be used with any appropriate suspension or biological sample, such as blood, bone marrow, cystic fluid, ascites fluid, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. It should also be understood that a target analyte can be a cell, such as ova or a circulating tumor cell (“CTC”), a circulating endothelial cell, a vesicle, a liposome, a protein, a nucleic acid, a biological molecule, a naturally occurring or artificially prepared microscopic unit having an enclosed membrane, parasites, microorganisms, or inflammatory cells.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise foul's described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

I/we claim:

1. A float, comprising:
a main body; and,
a porous layer at least partially encompassing the main body.

2. The float of claim 1, further comprising a reflective layer located in between the porous layer and a coating on the main body.

3. The float of claim 2, wherein the coating is porous.

4. The float of claim 2, wherein the reflective layer is porous.

5. The float of claim 2, further comprising a first horizontal extension wrapping circumferentially around the main body to create the top support member,
wherein the porous layer, the reflective layer, and the coating are layered on top of the main body and the first horizontal extension, thereby augmenting the top support member,
wherein the porous layer, the reflective layer, and the coating each include at least one pore, the pores being in fluid communication with each other,
and wherein a portion of the outermost layer which augments the top support member is non-porous.

6. The float of claim 1, further comprising a top support member which extends circumferentially around an upper portion of the main body.

7. The float of claim 6, wherein the porous layer extends underneath the top support member and into a top end cap, the top end cap being connected to the upper portion of the main body.

8. The float of claim 6, wherein the porous layer is layered on top of the top support member.

9. The float of claim 6, wherein the porous layer includes a first horizontal extension circumferentially around the porous layer to form the top support member.

10. The float of claim 6, wherein the main body includes a first horizontal extension circumferentially around the main body to create the top support member, and wherein the porous layer is layered on top of the main body and the first horizontal extension, thereby augmenting the top support member.

11. The float of claim 6, further comprising a bottom support member which extends circumferentially around a lower portion of the main body.

12. The float of claim 11, wherein the porous layer is layered on top of the bottom support member.

13. The float of claim 11, wherein the porous layer includes a second horizontal extension circumferentially around the porous layer to form the bottom support member.

14. The float of claim 11, wherein the porous layer extends underneath the bottom support member and into a bottom end cap, the top end cap being connected to the lower portion of the main body.

15. The float of claim 11, wherein the main body includes a second horizontal extension circumferentially around the main body to create the bottom support member, and wherein the porous layer is layered on top of the main body and the second horizontal extension, thereby augmenting the bottom support member.

16. The float of claim 1, wherein the main body is porous.

17. The float of claim 16, further comprising a pierceable segment in at least one of a top end cap or a bottom end cap.

18. The float of claim 17, wherein the pierceable segment is in fluid communication with the porous main body.

19. The float of claim 16, wherein the porosity of the main body is greater than the porosity of the porous layer.

20. The float of claim 1, further comprising an intermediary layer between the main body and the porous layer.

21. The float of claim 1, further comprising a space between the main body and the porous layer.

22. The float of claim 21, further comprising at least one porous layer support member.

23. The float of claim 22, further comprising at least one float support member to maintain the space between the float main body and the porous layer.

24. The float of claim 1, wherein the porous layer further comprises an overlay to attract a target analyte.

25. The float of claim 24, wherein the overlay also holds the target analyte.

26. The float of claim 1, wherein the porous layer is reflective.
